(19) United States
(12) Patent Application Publication
(10) Pub. No.: US 2009/0126674 A1
(43) Pub. Date: May 21, 2009

(54) ENGINE AND VEHICLE

(75) Inventors: Koji Takasu, Shizuoka (JP); Yuji Oku, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi, Shizuoka-ken (JP)

(21) Appl. No.: 12/097,093

(22) PCT Filed: Nov. 27, 2006
(86) PCT No.: PCT/JP2006/323614

§ 371 Date: Jun. 12, 2008

(30) Foreign Application Priority Data
Dec. 14, 2005 (JP) 2005-360151

(51) Int. Cl. F02F 1/24

(52) U.S. Cl. 123/193.5; 123/193.2; 123/470; 123/90.6

(57) ABSTRACT

In an engine, a cam cap is attached to an upper portion of a cylinder head by a plurality of bolts. The cam cap includes a fuel injection device fixing base. The fuel injection device fixing base has a fixed portion attachment element and an opening having an elongated shape. A fixed portion of a fuel injection device is fixed to this fixed portion attachment element by a bolt while the fuel injection device is inserted into the opening. In addition, the fuel injection device fixing base includes a camshaft fixing portion that fixes a camshaft. Furthermore, a head cover is attached to the cam cap by a plurality of bolts.

### BACKGROUND OF THE INVENTION

1. Field of the Invention

The present invention relates to an engine and a vehicle.

2. Description of the Related Art

In a vehicle such as a motorcycle, a fuel injection engine including a fuel injection device (injector) as a fuel supply is mounted instead of a conventional carburetor. Using this fuel injection device improves efficiency of fuel control, providing purification of exhaust gas, low-fuel consumption or other advantages.

Among such fuel injection devices as the fuel supply is a fuel injection device constituted by a nozzle in communication with a combustion chamber, an air-fuel injection valve attached to a cylinder head and a fuel injection valve that is connected to this air-fuel injection valve while injecting fuel into the air-fuel injection valve (see JP 2004-060610 A, for example).

In this fuel injection device, since an injector housing is integrally formed with a head cover, it is not necessary to arrange a member that constitutes the injector housing in the periphery of the cylinder head, thus achieving reduction in the number of components.

In the air-fuel injection engine described in JP 2004-060610 A, however, the injector housing holding the fuel injection device is integrally formed with the head cover. Therefore, the head cover is configured to be fixed to the cylinder head by a knock pin and the like so that the position of the fuel injection device with respect to the cylinder head is not changed by the relative position of the head cover and the cylinder head. This results in a very complicated configuration in some cases because of the positioning of the fuel injection device. Moreover, the injector housing is integrally formed with the head cover, thus leading to the complicated configuration and increased weight of the head cover, in spite of a demand for weight reduction.

In addition, a fuel supply passage and a compressed air supply passage that supply fuel and compressed air, respectively, to the fuel injection device held by the injector housing are forced to be provided in the head cover. This causes the configuration to be considerably complicated.

### SUMMARY OF THE INVENTION

In order to overcome the problems described above, preferred embodiments of the present invention provide an engine with a simplified configuration, improved positioning accuracy and rigidity and a vehicle including the same.

According to a preferred embodiment of the present invention, an engine includes a cylinder head that includes a valve, a cylinder arranged to define together with the cylinder head a combustion chamber, a fuel injection device that injects a mixture of fuel and air to the combustion chamber, a fixing member that is mounted on the cylinder head and fixes the fuel injection device, a cam member that opens and closes the valve, and a cam holding member that is fixed to the cylinder head and rotatably holds the cam member, wherein the fixing member and the cam holding member are integral with each other, and the fuel injection device includes a fixed portion that is fixed to the fixing member.

In the engine, the cylinder is arranged so as to form, together with the cylinder head including the valve, the combustion chamber. The fixed portion of the fuel injection device that injects the air-fuel mixture is fixed on the fixing member mounted on the cylinder head.

As described above, the fixing member is mounted on the cylinder head, so that positioning accuracy of the fixing member is ensured. Then, the fuel injection device is fixed to the fixing member, of which positioning accuracy is ensured, via the fixed portion, so that positioning accuracy and attachment rigidity of the fuel injection device and the cylinder head are improved. In addition, the fixing member allows the fuel injection device to be positioned with respect to the cylinder head. This prevents an increase in the number of components.

Moreover, the cam holding member that rotatably holds the cam member is fixed to the cylinder head, thereby enabling miniaturization and space saving of the engine.

Furthermore, the fixing member and the cam holding member are preferably integrally formed by casting or other suitable processing, resulting in easier manufacturing and a decrease in the number of the components. In addition, the necessity of positioning the fixing member and the cam holding member is eliminated, thus improving assembly performance.

The fixing member may include an opening into which the fuel injection device is inserted, and an attachment portion to which the fixed portion of the fuel injection device is attached. In this case, the fuel injection device is inserted into the opening of the fixing member while the fixed portion of the fuel injection device is attached to the attachment portion of the fixing member. Such a configuration allows the fuel injection device to be easily inserted into the combustion chamber through the opening while improving the positioning accuracy and the attachment rigidity of the fuel injection device and the cylinder head.

The fixed portion of the fuel injection device may be arranged so as to project in a side direction of the fuel injection device, the attachment portion of the fixing member may be arranged so as to project in a side direction of the opening of the fixing member, and the fixed portion of the fuel injection device abuts against the attachment portion of the fixing member while the fuel injection device is inserted into the opening of the fixing member. In this case, the fuel injection device is easily attached to the fixing member, and working efficiency is improved.

The attachment portion of the fixing member may be a recess arranged so as to project in the side direction of the opening of the fixing member, and the fixed portion of the fuel injection device may be fitted to the recess while the fuel injection device is inserted into the opening of the fixing member.

In this case, the fixed portion of the fuel injection device is fitted to the recess, so that the positioning accuracy and the attachment rigidity of the fuel injection device and the cylinder head are sufficiently improved.

The fuel injection device may include a fuel injector that injects fuel, an air-fuel mixture chamber that produces an air-fuel mixture by mixing the fuel injected by the fuel injector and air, an air-fuel mixture injector that injects the air-fuel mixture produced by the air-fuel mixture chamber, and a holding member that holds the fuel injector and the air-fuel mixture injector while including the fixed portion.

In this case, the fuel is injected by the fuel injector, and the injected fuel and air are mixed by the air-fuel mixture chamber, thereby producing the air-fuel mixture. The air-fuel mixture produced by the air-fuel mixture chamber is injected by the air-fuel mixture injector. The fuel injector and the air-fuel mixture injector are held by the holding member. Furthermore, the holding member has the fixed portion.

As described above, the fuel injector and the air-fuel mixture injector are integrated through the holding member, thereby eliminating the necessity of positioning the fuel injector and the air-fuel mixture injector. In addition, when the fuel injection device is attached to the engine, the fuel injector and the air-fuel mixture injector can be integrally handled. Furthermore, since the fuel injection device is provided separately from the engine, the fuel injection device can be attached to the assembled engine. Accordingly, workability of assembling the fuel injector and the air-fuel mixture injector is improved.

Moreover, a positional relationship between the fuel injector and the air-fuel mixture injector is fixed by the holding member, so that the positional relationship between the fuel injector and the air-fuel mixture injector is not affected by positions of other members of the engine. This improves positional accuracy of the fuel injector and the air-fuel mixture injector.

In addition, the fuel injector and the air-fuel mixture injector are integrally held by the holding member, so that rigidity of the fuel injection device is improved while its performance for sealing the air-fuel mixture is improved.

Furthermore, the fuel injector and the air-fuel mixture injector are integrally held by the holding member, so that the configuration of the engine is simplified and made compact.

Moreover, the fixed portion of the holding member is fixed to the fixing member of which positioning accuracy is ensured, so that the positioning accuracy and the attachment rigidity of the fuel injection device are improved.

The holding member may include an air supply passage through which air is supplied to the air-fuel mixture chamber. In this case, it is not necessary to additionally arrange the air supply passage within the engine. Thus, the internal configuration of the engine is simplified while workability of assembly is improved. Furthermore, the sealing performance of the air supply passage and the air-fuel mixture chamber is improved.

The engine may further include a head cover, and the head cover may be attached so as to cover, excluding the opening of the fixing member, the cylinder head while including a hole into which the fuel injection device is inserted.

In this case, the hole is provided in the head cover and the fuel injection device is inserted into the hole, so that the fuel injection device can be attached to the cylinder head.

Such a configuration does not require accuracy of attaching the head cover to the cylinder head, unlike conventional configurations. The fuel injection device is attached to the fixing member, so that the positioning accuracy of the fuel injection device is improved. In addition, the holding member such as an injector housing that holds the fuel injection device is not provided in the head cover, thus simplifying the configuration and reducing the head cover in weight.

Furthermore, the head cover is attached so as to cover the cylinder head, excluding the opening of the fixing member, thereby preventing oil between the cam member and the cam holding member from leaking out of the cylinder head.

The engine may further include an elastic member between the cylinder head and the head cover.

In this case, the head cover absorbs vibrations while insulating sound (radiated sound, for example) generated by the fuel injection device and so on. This provides sound insulation and vibration absorption.

The cam holding member may have, on a side of the cylinder head, a recess that holds the cam member. In this case, the cam member is held by the recess of the cam holding member on the side of the cylinder head, so that the fuel injection device and the engine can be miniaturized.

The fixing member may include a peripheral wall that projects so as to surround the opening, a flange may be provided in an end of the peripheral wall, and an edge of the hole of the head cover may abut against an end surface of the peripheral wall.

As described above, since the flange is formed in the end of the peripheral wall of the fixing member, the area of the end surface of the peripheral wall is increased. In this case, the edge of the hole of the head cover abuts against the end surface of the peripheral wall of the fixing member, so that the head cover is supported by the peripheral wall in a larger area. Thus, the head cover is reliably and stably fixed to the fixing member.

In addition, since the thickness of the fixing member excluding the end of the peripheral wall can be reduced, a bolt hole for attaching the fixing member to the cylinder head can be formed in the vicinity of a base of the peripheral wall. Thus, the head cover can be reliably fixed to the fixing member while the size of the opening of the fixing member is ensured and the fixing member is not enlarged.

According to another preferred embodiment of the present invention, a vehicle includes an engine and a drive wheel driven by power generated by the engine, the engine includes a cylinder head that includes a valve, a cylinder arranged so as to define together with the cylinder head a combustion chamber, a fuel injection device that injects a mixture of fuel and air to the combustion chamber, a fixing member that is mounted on the cylinder head and fixes the fuel injection device, a cam member that opens and closes the valve, and a cam holding member that is fixed to the cylinder head and rotatably holds the cam member, wherein the fixing member and the cam holding member are integral with each other, and the fuel injection device includes a fixed portion that is fixed to the fixing member.

In the vehicle, the drive wheel is driven by the power generated by the engine. In addition, in the engine, the cylinder is arranged so as to define together with the cylinder head including the valve the combustion chamber. The fixed portion of the fuel injection device that injects the air-fuel mixture is fixed on the fixing member mounted on the cylinder head.

As described above, the fixing member is mounted on the cylinder head, so that positioning accuracy of the fixing member is ensured. Then, the fuel injection device is fixed to the fixing member, of which positioning accuracy is ensured, via the fixed portion, so that positioning accuracy and attachment rigidity of the fuel injection device and the cylinder head are improved. In addition, the fixing member allows the fuel injection device to be positioned with respect to the cylinder head. This prevents an increase in the number of components.

Moreover, the cam holding member that rotatably holds the cam member is fixed to the cylinder head, thereby enabling simplification of the configuration, and miniaturization and space saving of the engine.

Furthermore, the fixing member and the cam holding member preferably are integrally formed by casting or other suitable processing, resulting in easier manufacturing and a decrease in the number of the components.

As described above, the positioning accuracy and rigidity are improved while the configuration is simplified in the vehicle. This enables reduction in weight and cost of the vehicle. In addition, the positioning accuracy of the fuel injection device is improved and the spray is appropriately supplied to the combustion chamber, so that higher performance of the vehicle can be realized.

According to an engine and a vehicle of various preferred embodiments of the present invention, positioning accuracy and rigidity are improved while configurations are simplified.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a vertical sectional view of an engine according to a preferred embodiment of the present invention.

FIG. 2 is a transverse sectional view of the engine of FIG. 1.

FIGS. 3A and 3B are perspective views showing a fuel injection device according to a present preferred embodiment of the present invention.

FIGS. 4A and 4B are partially fragmented sectional views of the fuel injection device of FIGS. 3A and 3B.

FIG. 5 is a perspective view showing a state where a cam cap is attached to a cylinder head.

FIG. 6 is a perspective view showing the configuration of the cam cap of FIG. 5.

FIGS. 7A and 7B are detail views of the cam cap of FIG. 6.

FIG. 8 is a perspective view showing a state where the cylinder head, the cam cap and the fuel injection device are assembled.

FIG. 9 is a perspective view showing a state where the head cover is attached to the state shown in FIG. 8.

FIG. 10 is a schematic view of a motorcycle provided with the engine including the fuel injection device according to a preferred embodiment of the present invention.

### DETAILED DESCRIPTION OF THE PREFERRED EMBODIMENTS

Hereinafter, description is made of a fuel injection device (injector) according to preferred embodiments of the present invention.

### (1) Overall Engine

First, a brief description is provided of the configuration of an engine to which the fuel injection device according to the present preferred embodiment is attached.

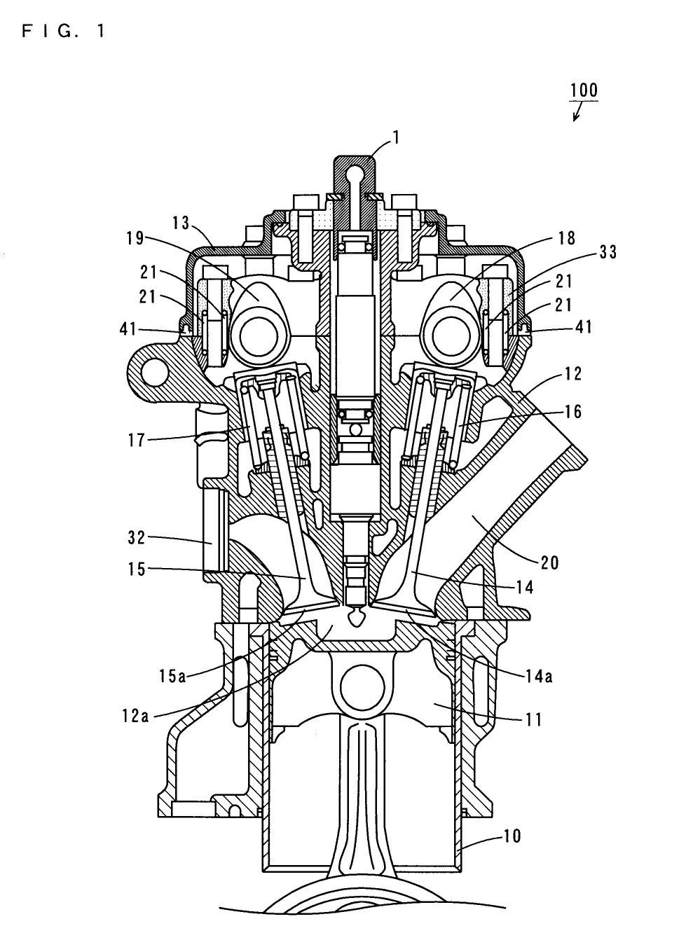

FIG. 1 is a vertical sectional view of the engine 100 according to the present preferred embodiment.

As shown in FIG. 1, the engine 100 includes a cylinder 10. A piston 11 is provided in the cylinder 10 so as to reciprocate up and down.

A cylinder head 12 is provided on the cylinder 10. The cylinder 10 and the cylinder head 12 define a combustion chamber 12a.

A cam cap 33 is mounted on the cylinder head 12 by knock pins 21. An upper portion of the cylinder head 12 is covered with a head cover 13 made of aluminum, magnesium, light alloy, fiber materials, resin or the like, for example, with an elastic member 41 made of rubber, for example, sandwiched therebetween. Note that the configuration of the cam cap 33 will be described later.

An intake port 20 is arranged so as to obliquely extend downward from one side of the cylinder head 12 toward its center.

A throttle body (not shown) is arranged so as to be connected upstream of the intake port 20 of the cylinder head 12. The throttle body and a funnel (not shown) attached to the throttle body constitute an intake pipe. Note that a throttle valve (not shown) is arranged in the throttle body so as to turn around a horizontal axis that crosses a central axis of the intake port 20.

An intake valve 14 is provided at a lower end opening of the intake port 20. The intake valve 14 includes a valve head 14a. This intake valve 14 is biased by springs 16 in such a direction that the valve head 14a closes the lower end opening of the intake port 20 (in an obliquely upward direction). An intake cam 18 is rotatably provided at an upper end of the intake valve 14. The intake cam 18 rotates to open/close the intake valve 14.

An exhaust port 32 is arranged so as to extend downward from the other side of the cylinder head 12 toward its center.

An exhaust valve 15 is provided at a lower end opening of the exhaust port 32. This exhaust valve 15 includes a valve head 15a. The exhaust valve 15 is biased by springs 17 in such a direction that the valve head 15a closes the lower end opening of the exhaust port 32 (in an obliquely upward direction). An exhaust cam 19 is rotatably provided at an upper end of the exhaust valve 15. The exhaust cam 19 rotates to open/close the exhaust valve 15.

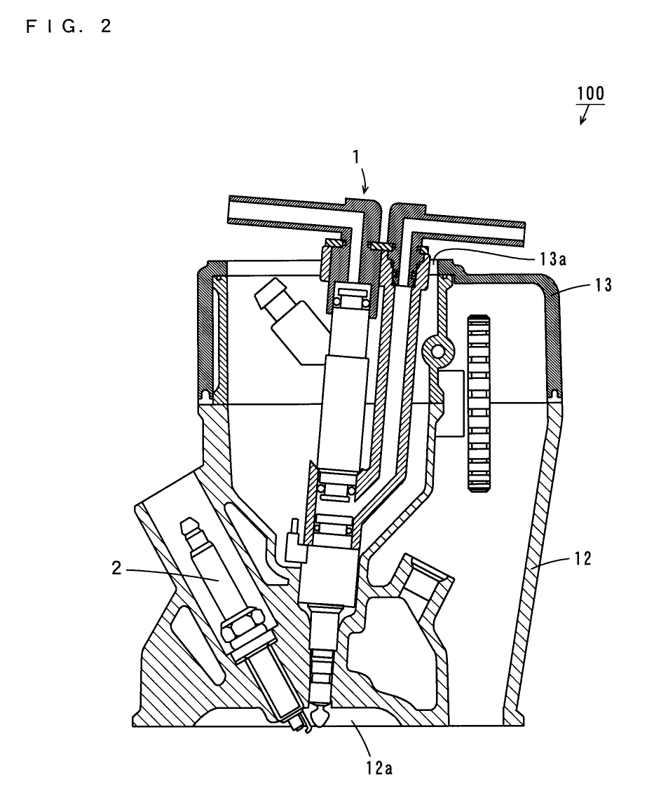

In FIG. 1, a fuel injection device 1 that injects fuel is arranged so as to extend toward inside of the combustion chamber 12a through a hole 13a, described later in FIG. 2, provided at the center of the head cover 13. Note that details of the configuration of the fuel injection device 1 will be described later.

FIG. 2 is a transverse sectional view of the engine 100 of FIG. 1.

As shown in FIG. 2, the hole 13a into which the fuel injection device 1 is inserted is provided in the head cover 13.

Here, in the present preferred embodiment, the fuel injection device 1 is provided through the hole 13a of the head cover 13 such that the tip thereof is in communication with the combustion chamber 12a while an upper portion thereof is fixed on the cam cap 33, described later. Details will be described later. Note that the cam cap 33 is used for fixing camshafts to which the intake cam 18 and the exhaust cam 19 are attached, respectively, and not shown in FIG. 2. The cam cap 33 will be described later.

Moreover, an ignition plug 2 is provided so as to be in communication with the combustion chamber 12a in FIG. 2.

### (2) The Configuration of the Fuel Injection Device

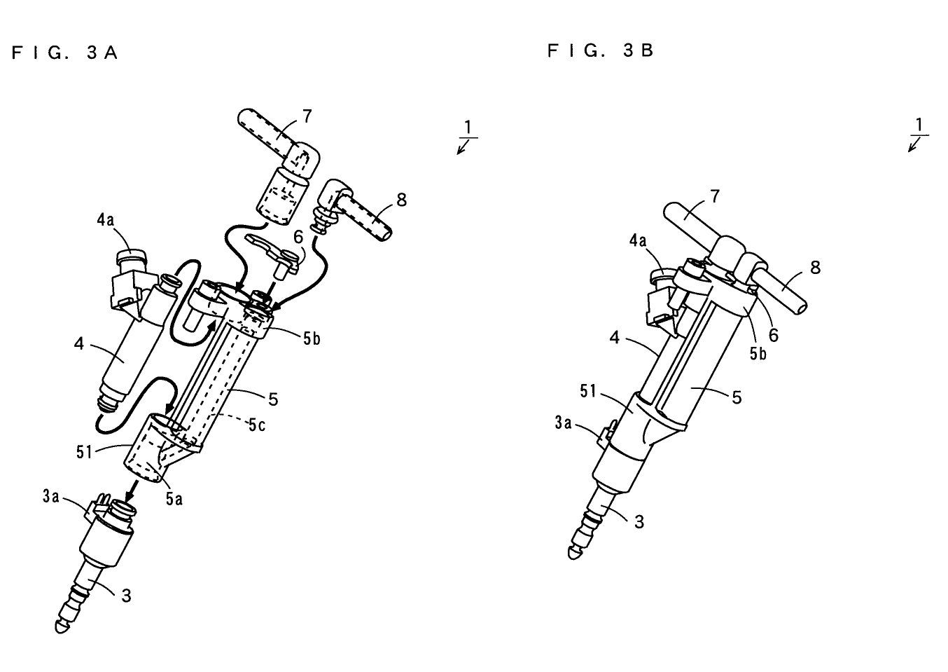

Next, the fuel injection device 1 according to the present preferred embodiment is described with reference to the drawings. FIGS. 3A and 3B are perspective views showing the fuel injection device 1 according to the present preferred embodiment. FIG. 3A shows disassembled components of the fuel injection device 1, and FIG. 3B shows the overall fuel injection device 1 into which the components are assembled.

As shown in FIG. 3A, the fuel injection device 1 according to the present preferred embodiment includes an air-fuel mixture injector 3, a fuel supplier 4, a fuel injection device holder 5, an insert piece 6, a fuel introducer 7 and an air introducer 8 as the components.

The fuel injection device holder 5 has an air-fuel mixture chamber 5a that is provided in the inside of the fuel injection device holder 5 and produces an air-fuel mixture by mixing supplied fuel and air, and includes a mixer 51 at its one end and a connector 5b at its other end. The fuel introducer 7 and the air introducer 8 are connected to the connector 5b, respectively, with the insert piece 6 sandwiched therebetween. Note that the fuel introducer 7 is connected to a fuel supply source (not shown) through a pipe (not shown), and the air introducer 8 is connected to an air supply source (not shown) through a pipe (not shown).

In addition, the fuel injection device holder 5 includes an air supply passage 5c that introduces air introduced from the air introducer 8 into the air-fuel mixture chamber 5a while extending between the air-fuel mixture chamber 5a and the connector 5b. That is, the air supply passage 5c through which air passes and the air-fuel mixture chamber 5a are integrally formed. The air-fuel mixture injector 3 is attached to one end of the mixer 51. This allows the air-fuel mixture injector 3 and the fuel supplier 4 to be integrated through the fuel injection device holder 5.

The fuel supplier 4 preferably is tubular, and the fuel is introduced into the tube to be supplied to the air-fuel mixture chamber 5a within the mixer 51. Moreover, one end of the fuel supplier 4 is attached to the other end of the mixer 51, and the other end of the fuel supplier 4 is attached to the connector 5b. That is, the fuel supplier 4 through which the fuel passes and the air-fuel mixture chamber 5a preferably are separately formed.

The air-fuel mixture injector 3 includes a wiring connector 3a, and the fuel supplier 4 includes a wiring connector 4a.

As shown in FIG. 3B, the fuel injection device 1 according to the present preferred embodiment is a unit into which the fuel supplier 4 for supplying the fuel and the fuel injection device holder 5 for supplying air are integrally formed.

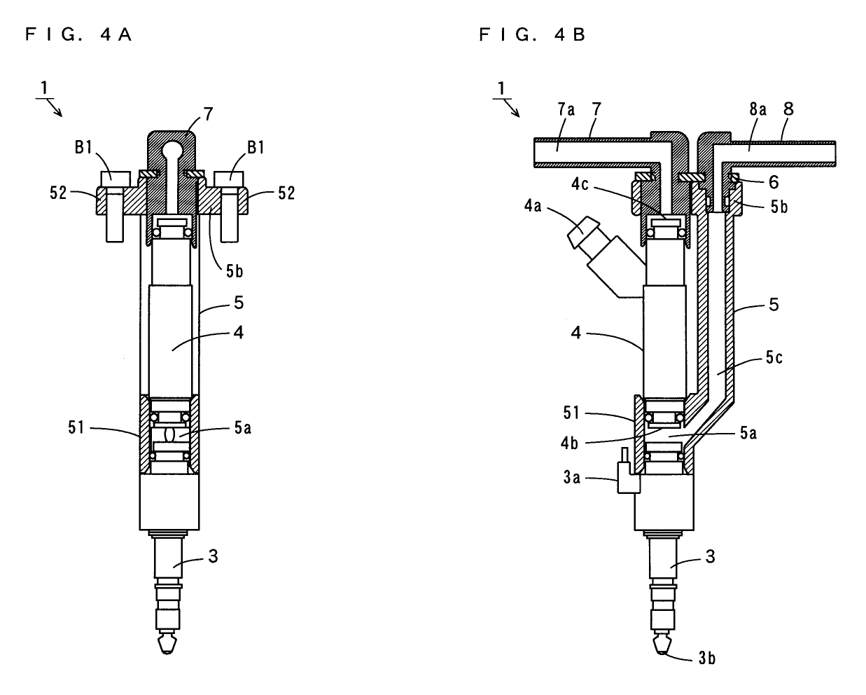

FIGS. 4A and 4B are partially fragmented sectional views of the fuel injection device 1 of FIGS. 3A and 3B. FIGS. 4A and 4B show vertical sectional views of the fuel injection device 1 in directions that are perpendicular to each other. Note that some of the components are not shown in FIG. 4A.

As shown in FIG. 4A, the connector 5b of the fuel injection device 1 includes two fixed portions 52 that project in a direction vertical to a direction in which the fuel introducer 7 and the air introducer 8 are attached.

The fixed portions 52 are fixed to the cam cap 33, described later, by bolts B1. As described above, the fuel injection device 1 can be positioned only by fixing the fixed portions 52 of the fuel injection device 1 by the bolts B1. Details will be described later.

In FIG. 4B, a fuel introduction passage 7a is formed within the fuel introducer 7, and an air introduction passage 8a is formed within the air introducer 8. This air introduction passage 8a is in communication with the air supply passage 5c, and air flowing into the air introduction passage 8a and the air supply passage 5c is supplied to the air-fuel mixture chamber 5a.

As shown in FIG. 4B, the fuel supplier 4 includes a fuel injection valve 4b at its downstream end and includes a fuel supply port 4c, to which the fuel is supplied, at its upstream end. The air-fuel mixture injector 3 includes an air-fuel mixture injection valve 3b at its downstream end.

In the present preferred embodiment, the fuel injection valve 4b and air-fuel mixture injection valve 3b are coaxially arranged. Thus, miniaturization is achieved while the mixture of fuel and air in the air-fuel mixture chamber 5a is efficiently injected from the air-fuel mixture injection valve 3b.

Furthermore, the air-fuel mixture chamber 5a is provided downstream of the fuel supplier 4, and the air-fuel mixture injector 3 is provided downstream of the air-fuel mixture chamber 5a.

As described above, the air-fuel mixture chamber 5a is provided between the fuel supplier 4 and the air-fuel mixture injector 3, so that the fuel supplier 4, the air-fuel mixture chamber 5 and the air-fuel mixture injector 3 are aligned. This allows the configuration to be simplified and miniaturized. Moreover, the air-fuel mixture is further efficiently produced in the air-fuel mixture chamber 5a while the produced air-fuel mixture is further efficiently injected from the air-fuel mixture injection valve 3b of the air-fuel mixture injector 3.

Note that opening/closing operations of the air-fuel mixture injection valve 3b are controlled by a controller (not shown) through a wiring (not shown) connected to the wiring connector 3a, and opening/closing operations of the fuel injection valve 4b are controlled by the controller through a wiring (not shown) connected to the wiring connector 4a.

### (3) The Configuration of the Cam Cap

Next, description is made of the cam cap 33 to which the fuel injection device 1 according to the present preferred embodiment is fixed.

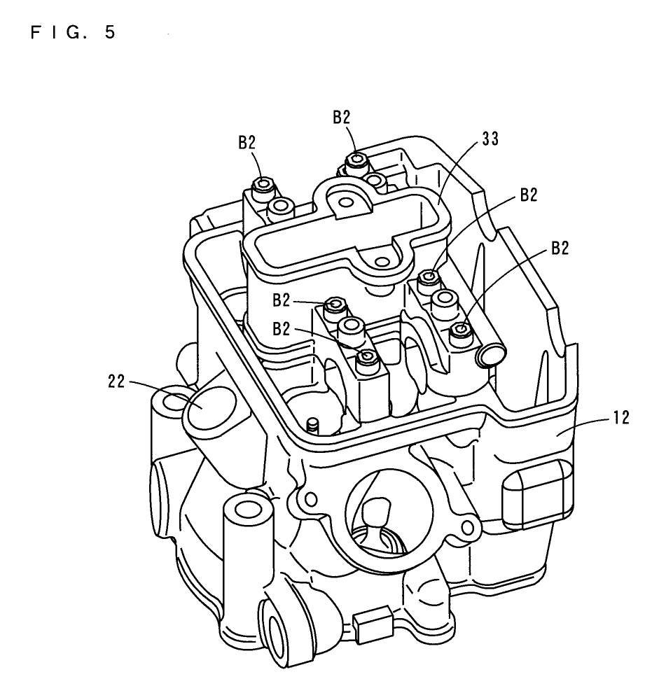

FIG. 5 is a perspective view showing a state where the cam cap 33 is attached to the cylinder head 12.

As shown in FIG. 5, the cam cap 33 is attached to the upper portion of the cylinder head 12 by a plurality of bolts B2.

Moreover, an insertion hole 22 into which the ignition plug 2 is inserted is provided at a side of the cylinder head 12. Note that the ignition plug 2 is not shown in FIG. 5.

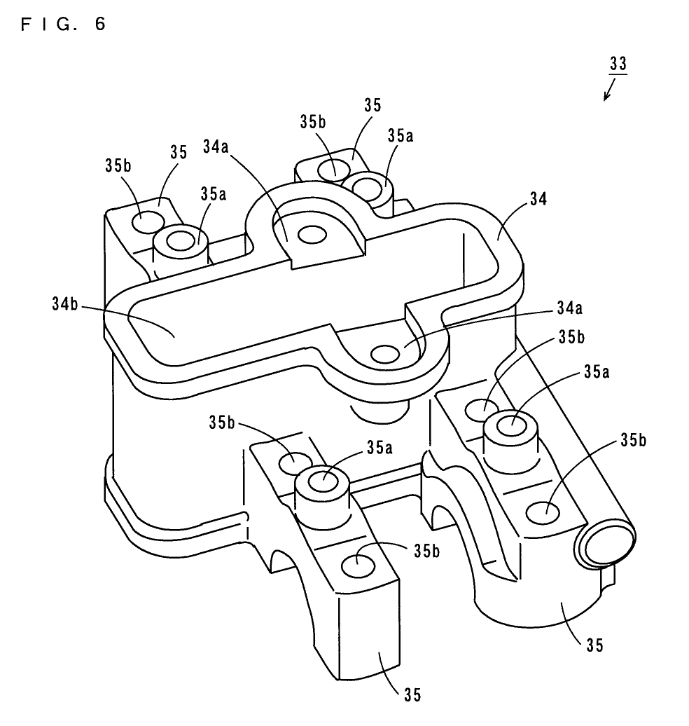

Next, the configuration of the cam cap 33 is described while referring to the drawings. FIG. 6 is a perspective view showing the configuration of the cam cap 33 of FIG. 5.

As shown in FIG. 6, the cam cap 33 includes a fuel injection device fixing base 34.

The fuel injection device fixing base 34 includes fixed portion attachment elements 34a and an opening 34b having an elongate shape. The fixed portions 52 of the fuel injection device 1 of FIG. 4A are fixed to the fixed portion attachment elements 34a by the bolts B1 while the fuel injection device 1 is inserted into the opening 34b.

In addition, the fuel injection device fixing base 34 includes camshaft fixing portions 35 that fix the camshafts of FIG. 6. In the present preferred embodiment, two of the camshaft fixing portions 35, for example, are provided at each side of the fuel injection device fixing base 34 so as to be vertical to a longitudinal direction of the opening 34b having the elongated shape. In such a configuration, one camshaft (not shown) is fixed by the two camshaft fixing portions 35 provided at one side, and another camshaft (not shown) is fixed by the two camshaft fixing portions 35 provided at the other side. Note that the fuel injection device fixing base 34 and the camshaft fixing portions 35 are integrally formed by casting or other suitable processing in the present preferred embodiment.

Furthermore, the camshaft fixing portions 35 include a plurality of (for example, four in FIG. 6) screws 35a for attaching the head cover 13 of FIG. 1 to the camshaft fixing portions 35 and a plurality of (for example, eight in FIG. 6: partially not shown) holes 35b into which the bolts B2 are inserted when the camshaft fixing portions 35 are attached to the cylinder head 12 of FIG. 5.

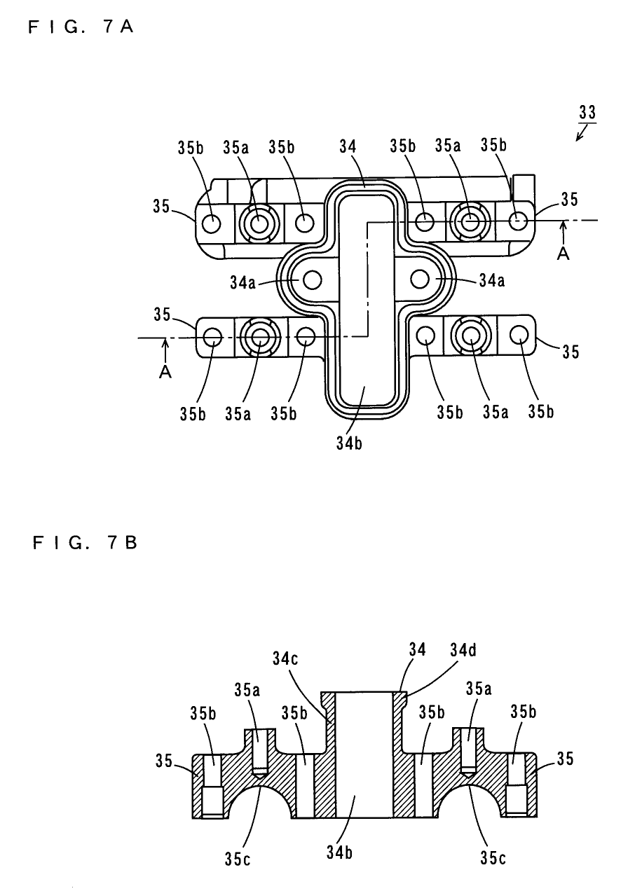

FIGS. 7A and 7B are detail views of the cam cap 33 of FIG. 6. FIG. 7A is a top view of the cam cap 33, and FIG. 7B is a sectional view taken along the line A-A of the cam cap 33 in FIG. 7A.

As shown in FIG. 7B, each of the camshaft fixing portions 35 of the cam cap 33 includes an abutment portion 35c, having a semi-circular cross section, which abuts against the camshaft. These abutment portions 35c abut against surfaces of the camshafts, respectively, so that the camshafts are fixed to the cam cap 33.

Here, the fuel injection device fixing base 34 includes a peripheral wall 34c that projects so as to surround the opening 34b. A flange 34d is formed at an upper end of this peripheral wall 34c. Accordingly, the upper end of the peripheral wall 34c has a larger thickness than those of other portions. A lower surface of an edge of the hole 13a of the head cover 13, described later, abuts against an upper end surface of the peripheral wall 34c.

### (4) Assembly (ASSY) State

Next, description is made of assembly of the cylinder head 12, the head cover 13, the cam cap 33 and the fuel injection device 1.

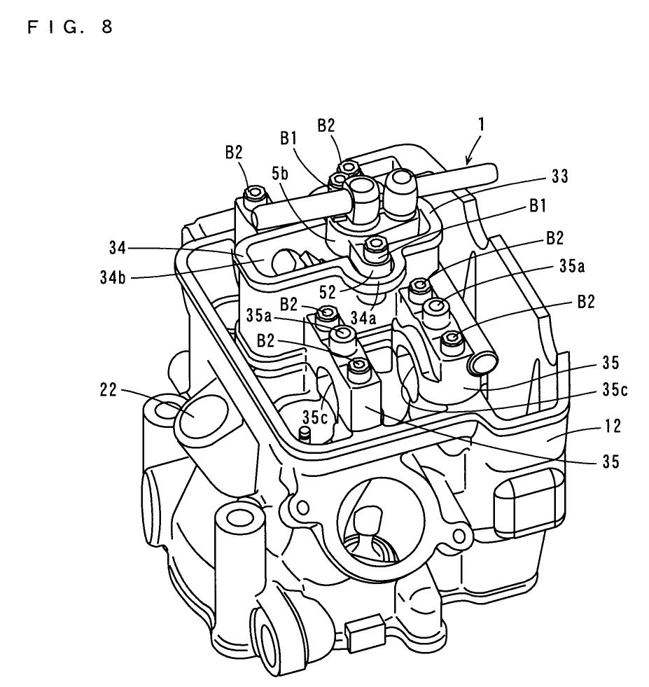

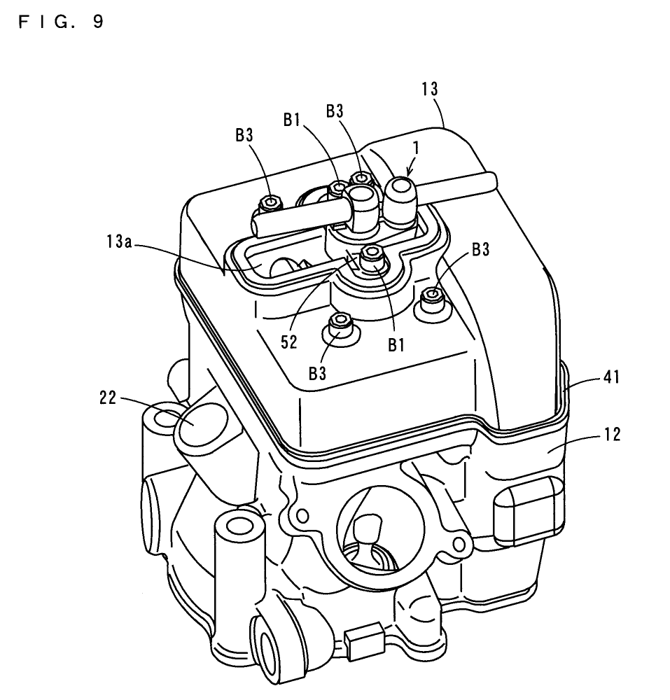

FIG. 8 is a perspective view showing a state where the cylinder head 12, the cam cap 33 and the fuel injection device 1 are assembled. FIG. 9 is a perspective view showing a state where the head cover 13 is attached to the state shown in FIG. 8. Note that the camshafts are not shown in FIG. 8.

As shown in FIG. 8, first, the cam cap 33 is attached to the upper portion of the cylinder head 12 by the plurality of bolts B2. Although the fuel injection device 1 is not assembled at this stage in the sequence of the assembly, it is shown in FIG. 8 for easier understanding.

Then, the head cover 13 shown in FIG. 9 is attached to the cam cap 33 by a plurality of bolts B3. The head cover 13 is provided with a plurality of holes corresponding to the screws 35a of the cam cap 33, and attached to the camshaft fixing portions 35 of the cam cap 33 by the plurality of bolts B3 through these holes.

In the present preferred embodiment, the elastic member 41 such as rubber, for example, is provided between the cylinder head 12 and the head cover 13. In this manner, the cylinder head 12 and the head cover 13 abut against each other with the elastic member 41 sandwiched therebetween, so that the head cover 13 absorbs vibrations while insulating sound (radiated sound, for example) generated by the fuel injection device 1 and a valve driving device (not shown) and so on. Such a configuration provides sound insulation and vibration absorption.

In FIG. 9, the head cover 13 includes the hole 13a into which the fuel injection device 1 is inserted as described in FIG. 1. The lower surface of the edge of the hole 13a of the head cover 13 abuts against the upper end surface of the peripheral wall 34c of the fuel injection device fixing base 34.

Next, the fuel injection device 1 is inserted into the hole 13a while the fixed portions 52 of the fuel injection device are attached to the fixed portion attachment elements 34a (FIG. 6) of the cam cap 33 below the head cover 13 by the bolts B1 in the above-described configuration.

### (5) Effects of the Present Preferred Embodiment

### (5-1) Effects Produced by the Configuration of the Fuel Injection Device

In the present preferred embodiment, the fuel supplier and the air-fuel mixture injector 3 are held by the fuel injection device holder 5.

As described above, the fuel supplier 4 and the air-fuel mixture injector 3 are integrated through the fuel injection device holder 5, thereby eliminating the necessity of positioning the fuel supplier 4 and the air-fuel mixture injector 3.

In addition, the fuel supplier 4 and the air-fuel mixture injector 3 can be integrally handled when the fuel injection device 1 is attached to the engine 100. Furthermore, since the fuel injection device 1 is provided separately from the engine 100, the fuel injection device 1 can be attached to the assembled engine 100. Accordingly, workability of assembling the fuel supplier 4 and the air-fuel mixture injector 3 is improved.

Moreover, since a positional relationship between the fuel supplier 4 and the air-fuel mixture injector 3 is fixed by the fuel injection device holder 5, the positional relationship between the fuel supplier 4 and the air-fuel mixture injector 3 is not affected by positions of other members in the engine 100. This improves positional accuracy of the fuel supplier 4 and the air-fuel mixture injector 3.

Furthermore, the fuel supplier 4 and the air-fuel mixture injector 3 are integrally held by the fuel injection device holder 5, so that rigidity of the fuel injection device 1 is improved.

In addition, the fuel supplier 4 and the air-fuel mixture injector 3 are integrally held by the fuel injection device holder 5, so that the configuration is simplified and made compact.

Moreover, in the present preferred embodiment, the fuel injection device holder 5 has the air supply passage 5c through which air is supplied to the air-fuel mixture chamber 5a, thereby eliminating the necessity of additionally arranging the air supply passage 5c within the engine 100. This simplifies the internal configuration of the engine 100 while improving workability of assembling. This also improves sealing performance of the air supply passage 5c and the air-fuel mixture chamber 5a.

Furthermore, the air supply passage 5c of the fuel injection device holder 5 is arranged so as to extend from the air-fuel mixture chamber 5a and along a side surface of the fuel supplier 4, so that the air supply passage 5c can be miniaturized and made compact.

In addition, the fuel supplier 4 includes the fuel injection valve 4b at its tip on the side of the air-fuel mixture chamber 5a and the fuel supply port 4c at its rear end, so that the fuel can be easily supplied from the outside of the head cover 13 of the engine 100 into the fuel supply port 4c. This prevents the internal configuration of the engine 100 from being complicated.

Moreover, the air-fuel mixture chamber 5a is formed in a space surrounded by the tip of the fuel supplier 4, the air-fuel mixture injector 3 and the fuel injection device holder 5, so that the configuration is further simplified. This allows the configuration to be further miniaturized and made compact.

### (5-2) Effects Produced by Fixing the Fuel Injection Device to the Cam Cap

In the present preferred embodiment, first, the cam cap 33 is mounted on the cylinder head 12 by the plurality of bolts B2 with the knock pins 21 inserted. Thus, positioning accuracy of the cam cap 33 with respect to the cylinder head 12 is ensured.

As described above, the fuel injection device 1 is then attached to the fuel injection device fixing base 34 of the cam cap 33, of which positioning accuracy is ensured, by the plurality of bolts B1. Such a configuration improves positioning accuracy and attachment rigidity of the fuel injection device 1.

In addition, the fuel injection device 1 can be positioned with respect to the cylinder head 12 by the cam cap 33. This does not increase the number of the components.

Moreover, when the fuel injection device 1 is attached to the fuel injection device fixing base 34 of the cam cap 33, the fuel injection device 1 is inserted into the hole 13a provided in the head cover 13 that is previously attached to the cylinder head 12. As described above, the hole 13a is provided in the head cover 13, so that the fuel injection device 1 can be attached to the cylinder head 12 through the cam cap 33.

Such a configuration does not require accuracy of attaching the head cover 13 to the cylinder head 12, unlike conventional configurations. Thus, the fuel injection device 1 is attached to the fuel injection device fixing base 34 of the cam cap 33, so that the positioning accuracy of the fuel injection device 1 is improved. In addition, an injector housing and the like that hold the fuel injection device 1 are not provided in the head cover 13, thereby simplifying the configuration and reducing the head cover 13 in weight.

Furthermore, in the present preferred embodiment, it is not necessary to ensure the positioning accuracy of the head cover 13 with respect to the cylinder head 12, unlike conventional techniques, thereby eliminating the necessity of firmly fixing the head cover 13 to the cylinder head 12 by a knock pin and the like. Utilizing such a configuration, the elastic member 41 made of rubber and the like is provided between the cylinder head 12 and the head cover 13. Accordingly, vibrations are absorbed by the head cover 13 while sound (radiated sound, for example) generated by the fuel injection device 1, the valve driving device (not shown) and so on is insulated by the head cover 13. Thus, sound insulation and vibration absorption can be realized.

### (5-3) Effects Produced by the Peripheral Wall of the Fuel Injection Device Fixing Base

Since the flange 34d is formed at the upper end of the peripheral wall 34c of the fuel injection device fixing base 34, the area of the upper end surface of the peripheral wall 34c is increased. In this case, the edge of the hole 13a of the head cover 13 abuts against the upper end surface of the peripheral wall 34c of the fuel injection device fixing base 34, so that the head cover 13 is supported by the peripheral wall 34c in a larger area. Thus, the head cover 13 can be reliably and stably fixed to the fuel injection device fixing base 34.

Moreover, the thickness of the fuel injection device fixing base 34 excluding the upper end of the peripheral wall 34c can be reduced, so that the holes 35b (see FIG. 7) for the bolts B2 used to attach the fuel injection device fixing base 34 to the cylinder head 12 can be formed in the vicinity of a base of the peripheral wall 34c. Thus, the head cover 13 can be reliably fixed to the fuel injection device fixing base 34 while the size of the opening 34b is ensured and the fuel injection device fixing base 34 is not enlarged.

### (6) Motorcycle Provided with the Engine Including the Fuel Injection Device

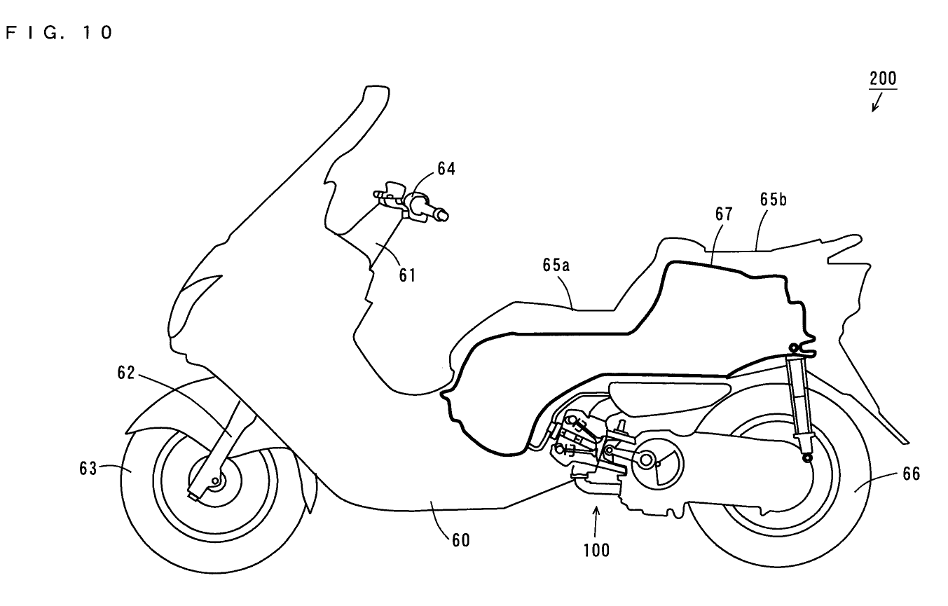

FIG. 10 is a schematic view of a motorcycle provided with the engine 100 including the fuel injection device 1 according the above-described preferred embodiment.

As shown in FIG. 10, in the motorcycle 200, a head 61 is provided at the front of a main body 60. The head 61 is provided with a front fork 62 that is swingable rightward and leftward.

A front wheel 63 is rotatably supported at a lower end of the front fork 62. The head 61 has a handle 64 attached to its upper end.

A main seat 65a and a tandem seat 65b are provided on the main body 60. Moreover, the engine 100 is provided below the main body 60. A rear wheel 66 is rotatably supported by the engine 100, a rear arm (not shown) and so on. The rear wheel 66 is driven by power of the engine 100. Note that a storage box 67 may be preferably provided within the main body 60 below the main seat 65a and the tandem seat 65b.

In the motorcycle 200 of FIG. 10, the engine 100 having the simplified configuration while including the fuel injection device 1 according to the above-described present preferred embodiment is preferably used, thereby reducing fuel consumption and exhaust gas.

In addition, vibrations and radiated sound are reduced in the motorcycle 200. This allows a rider to comfortably ride on the motorcycle.

### (7) Other Preferred Embodiments

While description is made of a case where the fuel injection device of the present invention is preferably applied to a motorcycle in the above-described preferred embodiment, the fuel injection device is applicable similarly to vehicles such as a three-wheeled motor vehicle and a four-wheeled motor vehicle.

While description is made of an example in which the fuel injection device fixing base 34 preferably is integrally formed into the cam cap 33 in the above-described preferred embodiment, the present invention is not limited to this. The fuel injection device fixing base 34 and the cam cap 33 may be provided separately from each other.

While description is made of an example in which the cylinder head 12 and the cam cap 33 preferably are configured separately from each other in the above-described preferred embodiment, the present invention is not limited to this. The cylinder head 12 and the cam cap 33 may be integrally formed.

Furthermore, the head cover 13 may be configured so as to be detached without detaching the fuel injection device 1 or the fuel introducer 7 and the air introducer 8.

In this case, the size of the hole 13a is suitably changed such that the fuel introducer 7 and the air introducer 8 pass through the hole 13a of the head cover 13 at the time of detaching the head cover 13.

### (8) Correspondences Between Elements Recited in Claims and Elements in Preferred Embodiments

In the following paragraph, non-limiting examples of correspondences between various elements recited in the claims below and those described above with respect to various preferred embodiments of the present invention are explained.

In the above-described preferred embodiment, the intake valve 14 and the exhaust valve 15 are examples of a valve, the fuel injection device fixing base 34 is an example of a fixing member, the intake cam 18 and the exhaust cam 19 are examples of a cam member, the camshaft fixing portion 35 is an example of a cam holding member, the fuel supplier 4 and the fuel injection valve 4b are examples of a fuel injector, the air-fuel mixture injector 3 and the air-fuel mixture injection valve 3b are examples of an air-fuel mixture injector, the cam cap 33 is an example of a fixing member and a cam holding member that are integrally formed, the fuel injection device holder 5 is an example of a holding member, the rear wheel 66 is an example of a drive wheel, the fixed portion attachment element 34a is an example of an attachment portion, the fuel injection device holder 5 is an example of a holding member, and the abutment portion 35c is an example of a recess of the cam holding member.

As the elements recited in the claims, various other elements having the structure or function as recited in the claims may be employed.

The present invention is applicable to various types of vehicles and the like including an engine such as a motorcycle and a four-wheeled motor vehicle.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-11. (canceled)

12: An engine comprising:
a cylinder head that includes a valve;
a cylinder arranged to define together with the cylinder head a combustion chamber;
a fuel injection device arranged to inject a mixture of fuel and air to the combustion chamber;
a fixing member mounted on the cylinder head and arranged to fix the fuel injection device;
a cam member arranged to open and close the valve; and
a cam holding member that is fixed to the cylinder head and arranged to rotatably hold the cam member; wherein
the fixing member and the cam holding member are integral with each other; and
the fuel injection device includes a fixed portion that is fixed to the fixing member.

13: The engine according to claim 12, wherein the fixing member includes an opening into which the fuel injection device is inserted, and an attachment portion to which the fixed portion of the fuel injection device is attached.

14: The engine according to claim 13, wherein the fixed portion of the fuel injection device is arranged so as to project in a side direction of the fuel injection device, the attachment portion of the fixing member is arranged so as to project in a side direction of the opening of the fixing member, and the fixed portion of the fuel injection device abuts against the attachment portion of the fixing member while the fuel injection device is inserted into the opening of the fixing member.

15: The engine according to claim 14, wherein the attachment portion of the fixing member is a recess arranged so as to project in the side direction of the opening of the fixing member, and the fixed portion of the fuel injection device is fitted to the recess while the fuel injection device is inserted into the opening of the fixing member.

16: The engine according to claim 12, wherein the fuel injection device includes a fuel injector arranged to inject fuel, an air-fuel mixture chamber arranged to produce an air-fuel mixture by mixing the fuel injected by the fuel injector and air,
an air-fuel mixture injector arranged to inject the air-fuel mixture produced by the air-fuel mixture chamber, and a holding member arranged to hold the fuel injector and the air-fuel mixture injector while including the fixed portion.

17: The engine according to claim 16, wherein the holding member includes an air supply passage through which air is supplied to the air-fuel mixture chamber.

18: The engine according to claim 13, further comprising a head cover attached so as to cover, excluding the opening of the fixing member, the cylinder head while including a hole into which the fuel injection device is inserted.

19: The engine according to claim 18, further comprising an elastic member between the cylinder head and the head cover.

20: The engine according to claim 12, wherein the cam holding member has, on a side of the cylinder head, a recess that holds the cam member.

21: The engine according to claim 18, wherein the fixing member includes a peripheral wall that projects so as to surround the opening, a flange is disposed in an end of the peripheral wall, and an edge of the hole of the head cover abuts against an end surface of the peripheral wall.

22: A vehicle comprising:
an engine; and
a drive wheel driven by power generated by the engine; wherein
the engine includes:
a cylinder head that includes a valve;
a cylinder arranged to define together with the cylinder head a combustion chamber;
a fuel injection device arranged to inject a mixture of fuel and air to the combustion chamber;
a fixing member that mounted on the cylinder head and arranged to fix the fuel injection device;
a cam member arranged to open and close the valve, and
a cam holding member fixed to the cylinder head and arranged to rotatably hold the cam member; wherein
the fixing member and the cam holding member are integral with each other; and
the fuel injection device includes a fixed portion that is fixed to the fixing member.
